(19) United States
(12) Patent Application Publication
(10) Pub. No.: US 2016/0318181 A1
(43) Pub. Date: Nov. 3, 2016

(54) AIRCRAFT PART WITH ROBOT ARM

(71) Applicants: AIRBUS, Blagnac (FR); AIRBUS GROUP INDIA PRIVATE LIMITED, Bangalore (IN)

(72) Inventors: Netra Gowda, Blagnac (FR); Ajit Krishnamohan, Bangalore (IN); Vincent Loubiere, Blagnac (FR)

(21) Appl. No.: 15/108,160

(22) PCT Filed: Dec. 26, 2013
(86) PCT No.: PCT/IN2013/000803

§ 371 Date: Jun. 24, 2016

(51) Int. Cl. B25J 9/06; F16M 11/18; B64D 11/00; F16M 13/02; B64D 45/00; F16M 11/10; F16M 11/20

(52) U.S. Cl. CPC B25J 9/06; F16M 11/105; F16M 11/18; F16M 11/2035; F16M 13/02; B64D 45/00; B64D 11/00

(57) ABSTRACT

An aircraft part, such as a cockpit or cabin, comprising a support structure and a robot arm. The robot arm has a proximal end attached to the support structure and a distal end configured to hold an electronic device. An actuation system drives the arm so that the arm distal end moves relative to the support structure. A non-volatile memory contains data, and a controller is programmed to drive the actuation system according to the data to move the arm distal end to a position determined by the data. The arm comprises a “snake-arm” with three or more links connected by a series of two or more joints, each joint connecting together a respective adjacent pair of the links and permitting relative rotation between the adjacent pair of links. The actuation system moves the arm distal end by causing a relative rotation between the links about their joints.

### FIELD OF THE INVENTION

The present invention relates to an aircraft part, such as a cockpit or cabin, comprising a robot arm for holding an electronic device such as a camera or touch screen device.

### BACKGROUND OF THE INVENTION

Aircraft pilots are increasingly using portable electronic touch screen devices, such as tablet computers, to display and record information relating to the aircraft and/or a flight plan. Such devices can be difficult and inconvenient to hold during use. There may also not be a convenient place to store the device when it is not in use, and once stored it may not be readily accessible if it is subsequently required.

### SUMMARY OF THE INVENTION

The present invention provides an aircraft part comprising a support structure; a robot arm having a proximal end attached to the support structure and a distal end adapted to hold an electronic device; an actuation system arranged to drive the robot arm so that the distal end of the robot arm moves relative to the support structure; a memory containing data; and a controller which is programmed to drive the actuation system according to the data in the memory in order to move the distal end of the robot arm to a position determined by the data in the memory.

The invention provides an improved arrangement for mounting an electronic device in an aircraft (for instance in the cockpit or cabin) in which the device can be automatically placed in a predetermined position defined by the data. This may be a retracted position in which the device is stowed away safely, or an extended position in which the device is accessible for use but does not block the pilot's view through the window or of critical flight controls.

The device may be moved by the robot arm in a straight line without rotating, but more typically the controller is programmed to drive the actuation system according to the data in the memory in order to rotate the distal end of the robot arm to an orientation determined by the data in the memory.

The robot arm may be a single arm which rotates or slides as it moves, or a pair of articulated links connected by a joint. However, more preferably, the robot arm comprises three or more links connected by a series of two or more joints, each joint connecting together a respective adjacent pair of the links and permitting relative rotation between the adjacent pair of links; wherein the proximal end attached to the support structure is a proximal one of the links, the distal end adapted to hold an electronic device is a distal one of the links, and the actuation system is arranged to move the distal end of the robot arm by causing a relative rotation between the links about their joints. The robot arm may have only three links, or it may, for example, have four, five or six links. A larger number of links provides a larger range of motion and a larger number of degrees of freedom for the motion of the robot arm, leading to improved flexibility and ergonomics.

The actuation system may comprise a plurality of drive cables (like tendons in a human arm) which are lengthened and shortened to move the robot arm, or it may comprise two or more motor units each arranged to cause a relative rotation between a respective pair of the links about their respective joint.

Typically, each motor unit comprises a motor casing which forms one of the links, and an output shaft which is coupled to an adjacent one of the links and can be rotated by the motor unit to cause a relative rotation between the motor casing and the adjacent one of the links. Typically, at least some of the output shafts are rigidly coupled to the casing of an adjacent motor unit. Each output shaft has an axis of rotation, and the axis of rotation of the output shaft typically changes direction by 90° between each joint in the series.

The electronic device may be a camera, a touch screen device such as a smartphone or tablet computer, or any other electronic device.

The proximal end of the robot arm may be permanently attached to the support structure by fasteners, or removably attached for instance by a sucker or clamp which permits the robot arm to be removed easily.

The support structure may comprise a window, a pillar between windows, or any part of an aircraft which is appropriately positioned and able to support the weight of the robot arm and electronic device.

Typically the aircraft part is an aircraft compartment, preferably a pressurized compartment such as the cockpit or cabin.

The distal end of the robot arm may comprise a pair of fingers which grip the device, a dock with a slot which receives the device, or any other end effecter suitable for holding an electronic device. Typically, the end effecter enables the device to be released from the distal end of the robot arm.

Two or more sensors may be provided, each arranged to detect an orientation between a respective pair of the links. The output from these sensors can then be used to determine a position and orientation of the distal end of the robot arm.

A user interface may be provided for receiving a command from a user which causes the controller to drive the actuation system according to the data in the memory in order to move the distal link to the position determined by the data in the memory. This user interface may be provided by the electronic device itself, it may be part of the robot arm, or it may be provided by a separate user interface in the cockpit or another part of the aircraft.

The memory may contain position data indicating a prohibited or “no-go” zone. In this case, the controller is programmed to drive the actuation system so that it actively resists movement into the prohibited zone or automatically moves the robot arm out of the prohibited zone if it has been previously been moved into the prohibited zone by a user.

### BRIEF DESCRIPTION OF THE DRAWINGS

Embodiments of the invention will now be described with reference to the accompanying drawings, in which:

FIG. 1 is a plan view of an aircraft;

FIG. 2 is a schematic view of a cockpit of the aircraft;

FIGS. 3a and 3b show a robot arm from two different viewing directions;

FIG. 4 shows a pair of adjacent motor units and the bracket connecting them;

FIG. 5 shows the end effecter of the robot arm;

FIG. 6 shows the proximal link of the robot arm; and

FIG. 7 shows the electrical connections within the robot arm.

### DETAILED DESCRIPTION OF THE PREFERRED EMBODIMENTS

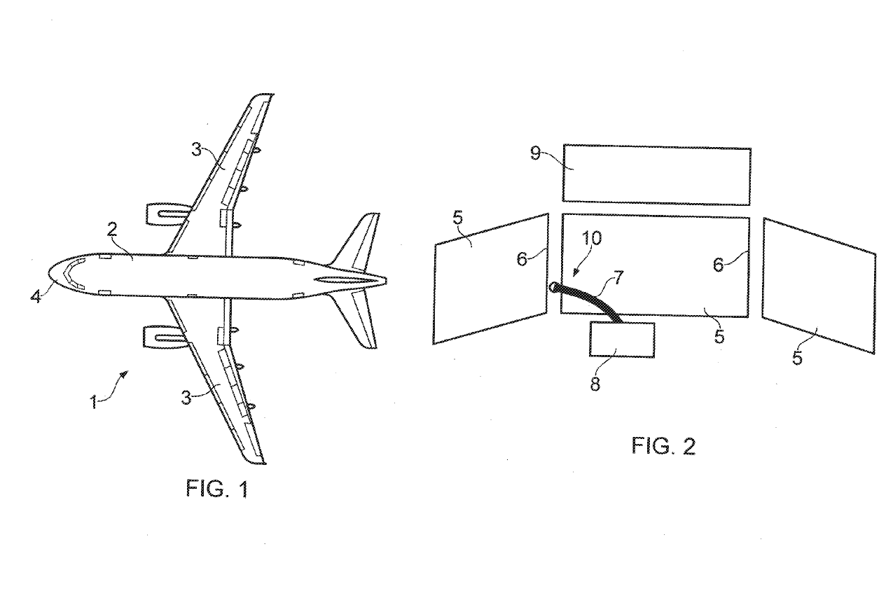

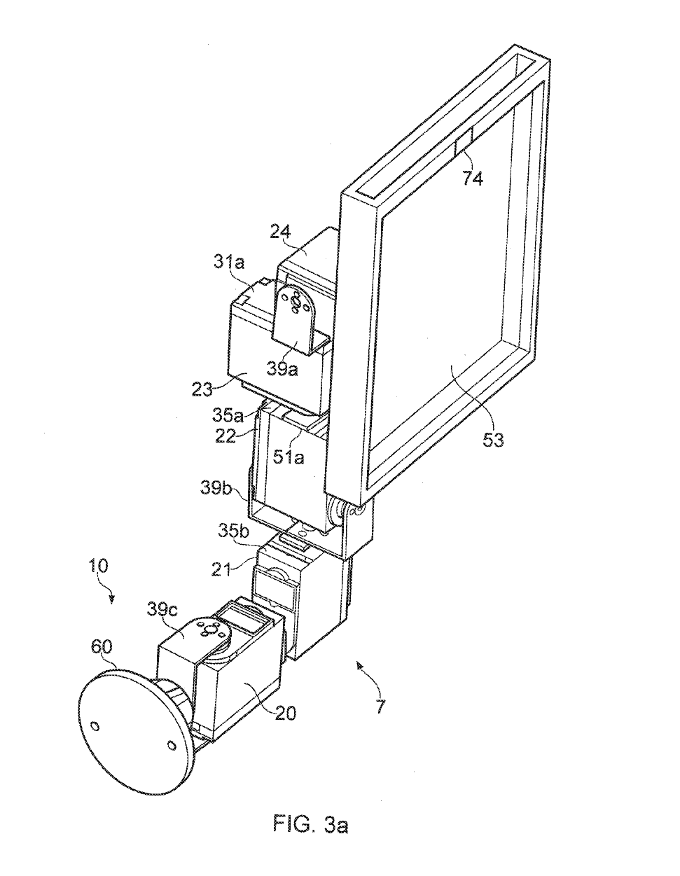

FIG. 1 is a plan view of an aircraft 1 with a fuselage 2 and a pair of wings 3. A cockpit 4 is provided at the front of the fuselage. FIG. 2 is a schematic view of the interior of the cockpit showing windows 5 separated by pillars 6, and a control panel 9 above the windows.

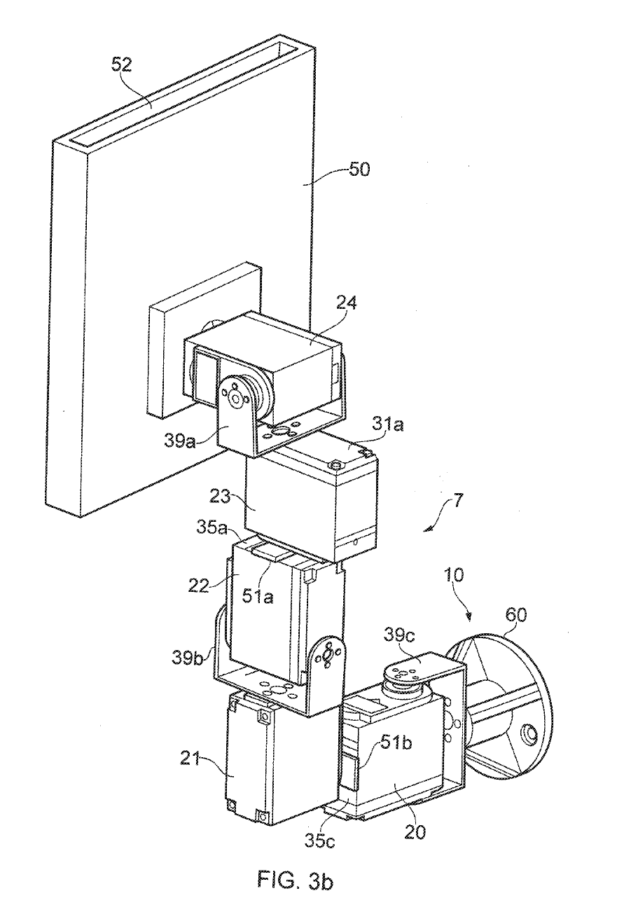

A robot arm 7 is installed in the cockpit with its proximal end 10 attached to one of the pillars 6, and its distal end (not shown) holding an electronic touch screen device 8. The robot arm is shown in more detail in FIGS. 3a and 3b.

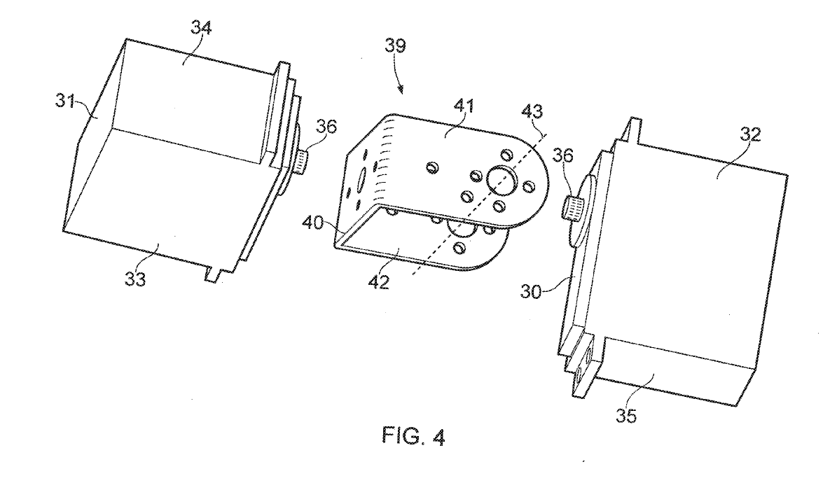

The robot arm 7 is a “snake-arm” robot comprising five identical servo motor units 20-24 connected together to form a series of articulated links. Two of the motor units are shown in FIG. 4. Each motor unit has a cuboid casing with a front face 30; a rear face 31; a pair of side faces 32, 33; an upper face 34; and a lower face 35. The housing contains a motor (not shown) with a rotary output shaft 36 which protrudes from the upper end of the front face 30 of the housing. Each motor unit may be, for example, a Dynamixel AX-12A available from Robotis (www.robotis.com) although other types of servo motor units may also be used such as a motor from the Dynamixel MX series.

The five motor units are connected together by two types of bracket, one of which is shown in FIG. 4. The bracket in FIG. 4 is a U-shaped bracket 39 with a base 40 and a pair of arms 41, 42. One of the arms 41 is rigidly attached to the shaft 36, and the other arm 42 is pivotally attached to the rear face 31 of the motor casing opposite to the shaft 36. When the shaft rotates, the U-shaped bracket rotates about the axis 43. Note that the U-shaped bracket is mounted to the motor unit in a different orientation to that shown in FIG. 4. The base 40 of the bracket is rigidly connected to an adjacent link by fasteners (not shown).

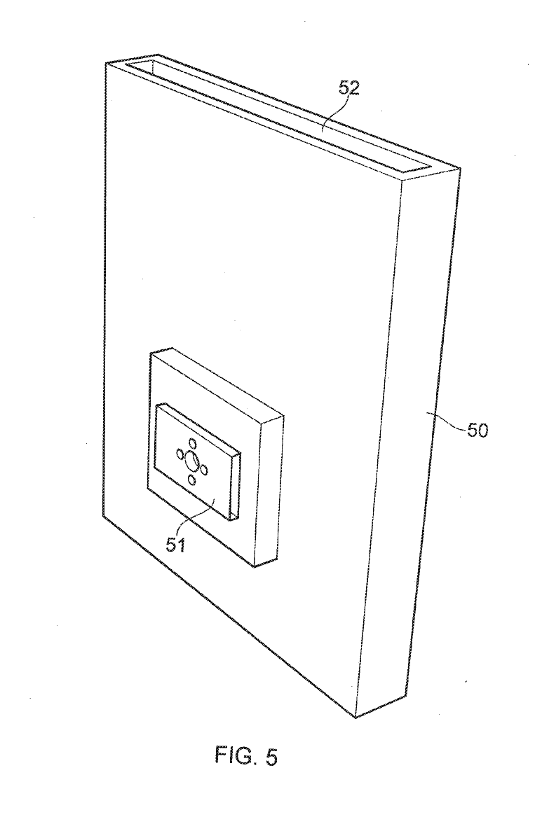

Returning to FIGS. 3a and 3b, the construction of the robot arm will now be described starting from its distal end. A distal motor unit 24 is provided with a U-shaped bracket 39a attached to its output shaft, and the touch screen device is rigidly attached to its lower face 35 by a mounting bracket 51 and dock 50 shown in FIG. 5.

The dock 50 has a slot 52 in its upper end. The touch screen device is inserted into the slot 52 and can be viewed through an opening 53 in the front face of the dock 50. Optionally the dock 50 includes a plug (not shown) which can be inserted into the touch screen device to power the device and communicate data to and from it. A proximity sensor 74 is provided which can sense the proximity of a user's hand

The base of the bracket 39a is rigidly attached to the rear face 31a of the casing of the adjacent motor unit 23 so that when the output shaft of the motor unit 24 rotates, the angle between the motor units 23, 24 changes.

The output shaft of the motor unit 23 is rigidly attached to the lower face 35a of the adjacent motor unit 22 by a bracket 51a so that when the output shaft of the motor unit 23 rotates, the angle between the motor units 22, 23 changes.

The motor unit 22 has a U-shaped bracket 39b attached to its output shaft, and the base of the bracket 39b is rigidly attached to the lower face 35b of the adjacent motor unit 21 so that when the output shaft of the motor unit 22 rotates, the angle between the motor units 21, 22 changes.

The output shaft of the motor unit 21 is rigidly attached to the lower face 35c of the adjacent proximal motor unit 20 by a bracket 5 lb so that when the output shaft of the motor unit 21 rotates, the angle between the motor units 20, 21 changes.

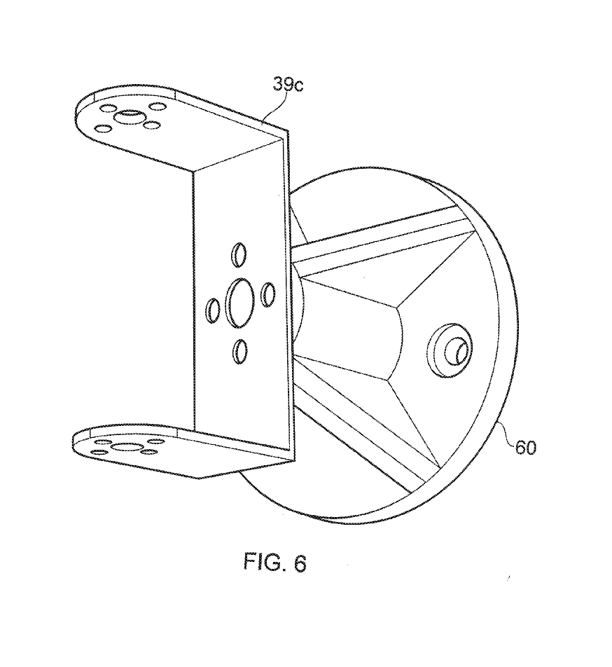

Finally, the proximal motor unit 20 has a U-shaped bracket 39c attached to its output shaft, and the base of the bracket 39c is rigidly attached by fasteners (not shown) to a circular mounting plate 60 shown in FIG. 6 which is rigidly connected in turn to the pillar 6 by fasteners (not shown). Therefore, when the output shaft of the proximal motor unit 20 rotates, the angle between the motor unit 20 and the pillar 6 changes.

In summary, the robot arm comprises a series of six articulated links connected by a series of five rotary joints, each joint connecting together a respective pair of the links. Each rotary joint only permits relative rotation of the pair of links about a single axis (the axis of the motor unit's output shaft). The links include a proximal link (the U-shaped bracket 39c and mounting plate 60) which is rigidly attached to the pillar 6, and a distal link (the distal motor unit 24, bracket 51 and dock 50) which is rigidly attached to the touch screen device. Each motor unit is arranged to change an angle between a respective pair of the links about their respective joint (by rotating its output shaft) so that the distal link moves relative to the proximal link. FIG. 3 shows the robot arm in a relatively retracted position. The combined rotations of the five output shafts can provide a complex motion for the distal link.

The axes of rotation of the output shafts alternate by 90 degrees between each successive pair of motor units. For example, the axis of rotation of the output shaft of the distal motor unit 24 is perpendicular to that of the second motor unit 23, and so on.

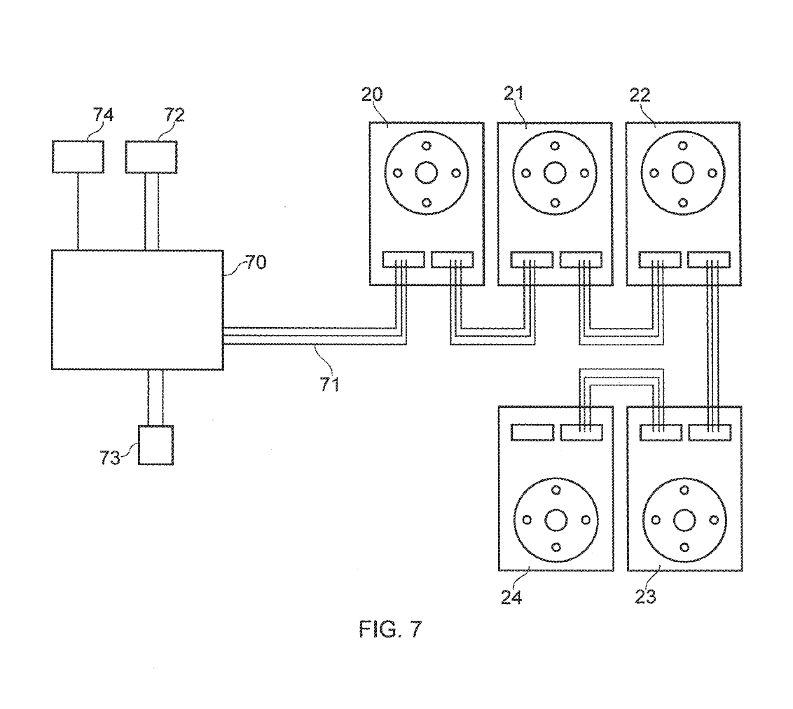

The motor units 20-24 are electrically connected to a microcontroller 70 by a serial bus 71 in a daisy-chain fashion as shown in FIG. 7. Each motor unit receives a drive signal from the microcontroller 70 which causes it to rotate its output shaft to a position set by the drive signal (for instance using pulse width modulation (PWM)). Also the microcontroller can instruct the motors to lock the motors, so that they resist manual movement of the arm from a preset position or into a predetermined “no-go zone” as described below. Each motor unit has its own unique address, and is operable independently of the other motor units.

Each motor unit also has position, speed and load sensors which detect the rotary position, rotary speed and rotary load of the output shaft and communicate this feedback data back to the microcontroller 70. The rotary position of each motor's output shaft indicates the angle between a respective pair of the links, and once the rotary positions of all of the motors is known, the microcontroller can determine the position and orientation of the touch screen device.

When the proximity sensor 74 senses the proximity of a user's hand, then the microcontroller instructs the motors to unlock their output shafts 36 so that the robot arm 7 can be moved manually by a user (for example, a pilot), for example by the user gripping the touch screen device and drawing it towards himself. Alternatively, the robot arm 7 can be moved automatically by actuating the motor units 20-24 in accordance with the drive signals from the microcontroller 70

When the user removes his hand after manually moving the device to a desired position, the proximity sensor 74 senses the removal of the user's hand and the motor output shafts 36 are locked by the microcontroller 70 to resist movement of the robot arm under the action of gravity. Therefore, a user can manipulate the touch screen device manually into the desired position and then let go and the robot arm will maintain its position.

The microcontroller 70 is connected to a memory 72 which stores data indicating a plurality of predetermined positions and orientations into which the robot arm can automatically be moved under the action of the motors. This data may comprise, for example, five motor positions, each indicating a rotary position of a respective one of the motor output shafts. A user can select one of the predetermined positions/orientations with a user interface 73. The microcontroller 70 then commands the motors to move to the various positions indicated by the data so that they place the distal link in the selected position and orientation.

The memory 72 also stores a retracted position in which the touch screen device is held well away from the pilot and in a position and orientation which does not cause significant obstruction of the pilot's view out of the windows 5 or of vital controls such as the control panel 9.

Different users may have different preferred retracted and deployed positions, and the memory 72 may store various different retracted and deployed positions which may be selected by different users according to their preference. A new predetermined position and orientation may be set by manually moving the robot arm into a desired position/orientation and then saving it in the memory 72 using the user interface 73. The new predetermined position/orientation may subsequently be selected by a user at a later point in time when the robot arm is in a different position/orientation, and the robot arm will then automatically move itself back into the new predetermined position/orientation.

The robot arm may automatically move itself into a retracted position if an emergency situation is detected while it is in an extended position.

The memory 72 may also store one or more prohibited or “no-go” zones into which the microcontroller 70 will not allow the touch screen device to be moved. If a user attempts to manually move the robot arm into such a “no-go” zone, then the motors are locked by the microcontroller 70 to actively resist movement into the “no-go” zone. Alternatively, if the user moves the touch screen device into the “no-go zone” then as soon as he releases the touch screen device, the motors automatically move the robot arm back out of the “no-go” zone. Alternatively, the robot arm may be provided with a feedback device which provides feedback to the user when they have moved the touch screen device into the “no-go zone”. For instance, the feedback device might provide haptic feedback or vibration via the robot arm by operation of the motors, or it might be a loudspeaker which emits an audio alarm.

The microcontroller 70 and/or the memory 72 and/or the user interface 73 may be provided by the touch screen device itself, they may be part of the robot arm, or they may be provided by a separate module in the cockpit or another part of the aircraft. Optionally the microcontroller 70 and/or the memory 72 and/or the user interface 73 may be provided by a smartphone or other electronic device which communicates wirelessly with the motors.

Optionally the robot arm includes one or more movement sensors to detect movement of other objects in the cockpit. The robot arm may have a dynamic collision avoidance system to automatically move the robot arm to avoid collisions with other objects within the cockpit.

The mounting device may not be bolted to a pillar between windows of the cockpit but may instead be attached to any window, structural element or control panel of the cockpit by any known mounting mechanism. For example, the robot arm may be mounted via one or mechanical fasteners or clips or suckers. In one particular embodiment, the robot arm may include a sucker for attaching the robot arm to a window of the cockpit.

The robot arm of FIG. 3 has five servo motor units, but there may be more or fewer depending on the range of motion and flexibility required. Successive axes of rotation of the output shafts need not alternate by 90 degrees, but instead the angular offset between the axes of rotation may be any angle, including 0 degrees. In other embodiments the manner of attachment between one motor unit's rotary actuator and the adjacent motor unit's housing may be different, for example the bracket geometry may vary.

Instead of being installed in the cockpit, the robot arm 7 can be installed in another pressurized compartment of the aircraft, such as a cabin. If it is installed in a cabin, then the robot arm can hold an electronic touch screen device for a flight attendant to use, for example, to check the availability of seats and to record in real-time information such as passenger meal requests or faulty equipment.

Although the invention has been described above with reference to one or more preferred embodiments, it will be appreciated that various changes or modifications may be made without departing from the scope of the invention as defined in the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-18. (canceled)

19. An aircraft part comprising:
a support structure;
a robot arm having a proximal end attached to the support structure and a distal end configured and adapted to hold an electronic device;
an actuation system configured and arranged to drive the robot arm so that the distal end of the robot arm moves relative to the support structure;
a non-volatile memory containing data; and
a controller programmed to drive the actuation system according to the data in the memory to move the distal end of the robot arm to a position determined by the data in the memory.

20. An aircraft part according to claim 19, wherein the controller is programmed to drive the actuation system according to the data in the memory to rotate the distal end of the robot arm to an orientation determined by the data in the memory.

21. An aircraft part according to claim 19,
wherein the robot arm comprises three or more links connected by a series of two or more joints, each joint connecting together a respective adjacent pair of the links and permitting relative rotation between the adjacent pair of links;
wherein the proximal end attached to the support structure is a proximal one of the links, the distal end adapted to hold an electronic device is a distal one of the links, and the actuation system is arranged to move the distal end of the robot arm by causing a relative rotation between the links about their joints.

22. An aircraft part according to claim 21,
wherein the robot arm comprises four or more links connected by a series of three or more joints, each joint connecting together a respective adjacent pair of the links and permitting relative rotation between the adjacent pair of links;
wherein the proximal end attached to the support structure is a proximal one of the links, the distal end adapted to hold an electronic device is a distal one of the links, and the actuation system is arranged to move the distal end of the robot arm by causing a relative rotation between the links about their joints.

23. An aircraft part according to claim 21, wherein the actuation system comprises two or more motor units each arranged to cause a relative rotation between a respective pair of the links about their respective joint.

24. An aircraft part according to claim 23, wherein each motor unit comprises a motor casing which forms one of the links, and an output shaft which is coupled to an adjacent one of the links and can be rotated by the motor unit to cause a relative rotation between the motor unit casing and the adjacent one of the links.

25. An aircraft part according to claim 24, wherein each output shaft has an axis of rotation, and the axis of rotation of each successive output shaft changes direction by 90° between each joint in the series.

26. An aircraft part according to claim 23, wherein at least one of the output shafts is rigidly coupled to the casing of an adjacent motor unit.

27. An aircraft part according to claim 19, further comprising an electronic device held by the distal end of the robot arm.

28. An aircraft part according to claim 27, wherein the electronic device is a touch screen device.

29. An aircraft part according to claim 19, further comprising two or more sensors, each sensor arranged to detect a relative orientation between a respective pair of the links.

30. An aircraft part according to claim 19, further comprising a user interface for receiving a command from a user which causes the controller to drive the actuation system according to the data in the memory to move the distal end of the robot arm to the position determined by the data in the memory.

31. An aircraft part according to claim 19, wherein,
the memory contains position data indicating a prohibited zone; and
the controller is programmed to drive the actuation system so that it actively resists movement into the prohibited zone.

32. An aircraft part according to claim 19, wherein,
the memory contains position data indicating a prohibited zone; and
the controller is programmed to drive the actuation system so that it automatically moves the robot arm out of the prohibited zone.

33. An aircraft part according to claim 19, wherein
the memory contains position data indicating a prohibited zone; and
the robot arm is configured and arranged to provide feedback to a user when the user has moved the electronic device into the prohibited zone.

34. An aircraft part according to claim 19, wherein the robot arm further comprises a proximity sensor, and the controller is arranged to unlock the actuation system when the proximity sensor senses the proximity of a user's hand to enable the user to manipulate the robot arm manually.

35. An aircraft part according to claim 19, wherein the aircraft part is an aircraft compartment.

36. An aircraft part according to claim 19, wherein the aircraft part is a cockpit or cabin.

37. An aircraft comprising an aircraft part comprising:
a support structure;
a robot arm having a proximal end attached to the support structure and a distal end configured and adapted to hold an electronic device;
an actuation system configured and arranged to drive the robot arm so that the distal end of the robot arm moves relative to the support structure;
a non-volatile memory containing data; and
a controller programmed to drive the actuation system according to the data in the memory to move the distal end of the robot arm to a position determined by the data in the memory.
